(19) United States
(12) Patent Application Publication
(10) Pub. No.: US 2010/0089379 A1
(43) Pub. Date: Apr. 15, 2010

(54) Grill

(75) Inventor: Xiaoli Cheng, Fujian (CN)

Correspondence Address: KENING LI;PINSENT MASONS LLP, c/o FOUNTAIN LAW GROUP, INC, 18201 Von Karman Avenue, Suite 960, Irvine, CA, 92612, US

(73) Assignee: TSANN KUEN (CHINA) ENTERPRISE CO., LTD., Fujian (CN)

(21) Appl. No.: 12/254,211

(22) Filed: Oct. 20, 2008

(30) Foreign Application Priority Data
Oct. 18, 2007 (CN) 200710009700.7

(51) Int. Cl. A47J 37/07; F24C 15/00

(52) U.S. Cl. 126/25 R; 126/39 B

(57) ABSTRACT

A grill comprising a base, an upper shell, an upper pan located in the upper shell and an lower pan located in the base, the upper shell has a left lever and a right lever in the two sides respectively, one end of each lever pivotally connecting to the back portion of the two sides of the base respectively, the lower pan pivotally connecting to at least a lever via a sleeve, wherein there is a sliding block in the sleeve which can slide towards the axis direction of the sleeve; the side of the sliding block has a position protrusion, the pivotal connection portion of the lower pan has a corresponding position groove for the position protrusion sliding towards the axis direction, the pivotal connection portion of the said lever has a corresponding arc-limiting groove for the position protrusion rotating limitedly, said sleeve has a corresponding position opening to the position groove. The upper pan and lower pan of the grill of the present invention can be opened to about 105 degrees and about 180 degrees or forms a “V”-shape just by the simple structure composed of a sleeve, sliding block, spring and button, so it is simple, reliable and lower-cost.

### FIELD OF THE INVENTION

The present invention relates to a connecting structure between the upper pan and lower pan of a grill, and to a grill with adjustable opening angle between the upper and lower grill.

### BACKGROUND OF THE INVENTION

A grill often comprises a base, an upper shell, an upper pan located under the upper shell and a lower pan located on the base, wherein the base and the shell forms a pivotal connection so that the upper pan and the lower pan can be closed or opened. The upper shell has a left side and right side, and a left lever and a right lever on the two sides respectively. One of the ends of the lever is pivotally connected to the back portion of its corresponding side of the lower pan, and the middle portion of the lever is pivotally connected to the middle portion of the side of the upper shell. The other ends of the two levers are connected via a handle. Usually, for the convenience of grilling, the upper pan and the lower pan must be positioned at an angle of about 105 degrees to 180 degrees between them, thus a position mechanism is needed between the left lever, right lever, the upper shell and the base.

### SUMMARY OF THE INVENTION

The main object of the present invention is to provide a grill with a simple structure and adjustable opened-angle between 105 degrees and 180 degrees formed by the upper pan and lower pan.

This and other objects of the present invention are achieved as follows.

In one embodiment, a grill of the present invention comprises a base, an upper shell, an upper pan located in the upper shell and an lower pan located in the base; the upper shell has a left lever and a right lever in the two sides respectively, one end of each lever is pivotally connected to the back portion of each of its corresponding side of the base, the lower pan is pivotally connected to at least a lever via a sleeve, and there is a sliding block in the sleeve which can slide along the axis direction of the sleeve; the side of the sliding block has a position protrusion, the pivotal connection portion of the lower pan has a corresponding position groove for the position protrusion sliding along the axis direction, the pivotal connection portion of the lever has a corresponding arc limiting groove for the position protrusion to rotate limitedly, the sleeve has a corresponding position opening to the position groove; the lever has a button for the sliding block to slide from the position between the lever and the pivotal connection portion of the lower pan into the pivotal connection portion of the lower pan.

In the abovementioned grill, the sleeve inserts into the pivotal connection portion of the lower pan from the opposite outer side of pivotal connection portion of the said lever, and the outer side has a flange to limit the distance of its sliding movement; the button includes a head and a shaft with a size smaller than the head, wherein the shaft inserts into the sleeve, and a spring mounted between the head and the outer side of the sleeve.

The sliding block is fixed in the inner side of the said shaft via a bolt.

The side opposite to the lower pan of the pivotal connection portion of the said lever forms a assemble groove, where the flange of the outer side of the said sleeve, the head of the button and the spring between them are positioned.

The angle of the said arc limit groove is 105 degrees.

The sleeve forms non-reversible cooperation with the opposite pivotal connection portion of the lower pan and reversible cooperation with the pivotal connection portion of the lever.

Furthermore, each of the upper shell has a left lever and a right lever has an extending terminal. The two terminals of the two levers are connected with each other by a handle, and the levers are pivotally connected to the two sides of the said upper shell.

There is a shaft mounted on the sleeve, one end of the shaft forms a ring sheathed on the sleeve, the ring is arranged between the pivotal connection portion of the right lever and the pivotal connection portion of the lower pan; the lever connected to the lower portion of the right side of the said upper shell via a sliding device; the internal edge of the ring of the said shaft has an arc opening cooperating to the position protrusion of the said sliding block.

The sliding device comprising a sliding groove on the shaft and a rivet on the right side of the said upper shell, the sliding groove of the shaft connected slidably via the rivet.

The side of the periphery of the ring toward to the pivotal connection portion of the lower pan has a arc protruding rib, the arc protruding rib and the periphery of the pivotal connection portion of the lower pan forms rotating cooperation.

The portion of the left lever and the right lever connecting to the handle bended towards the top of the upper shell, the lower portion of the front portion of the said base has a foot, the said upper pan and lower pan forms a “V”-shape when they opened to the utmost position.

In another embodiment, the grill comprises a base, an upper shell and an upper pan located in the upper shell and an lower pan located in the base, the upper shell has a left lever and a right lever in the two sides respectively, one end of each lever connected with each other by a handle, and the other ends of the left lever and right lever pivotally connecting to the back portion of the two sides of the base respectively, the said lower portion of the front portion of the said base has a foot, the said upper pan and lower pan forms a “V”-shape when they opened to the utmost position by the supporting of the foot and the handle.

The lower pan pivotally connecting to at least a lever via a sleeve, and there is a sliding block in the sleeve which can slide through the pivotal shaft; the side of the said sliding block has a position protrusion, the pivotal connection portion of the lower pan has a corresponding position groove for the position protrusion sliding through the shaft, the pivotal connection portion of the said lever has a corresponding arc limiting groove for the position protrusion rotating limitedly, the said sleeve has a corresponding position opening to the position groove; the said lever has a button for the sliding block sliding from the position between the lever and the pivotal connection portion of the lower pan into the pivotal connection portion of the lower pan.

The said sleeve inserts into the pivotal connection portion of the lower pan from the outer side opposite to the lower pan of pivotal connection portion of the said lever, and the outer side has a flange to limit the distance of its sliding movement; the said button includes a head and a shaft with smaller size, the shaft inserts into the said sleeve, and a spring mounted between the head and the out side of the sleeve. The said sliding block fixed in the internal side of the said shaft via a bolt.

From abovementioned descriptions, the present invention has the following advantages compared with the prior art: firstly, the present invention achieves the object that the upper pan and the lower pan can be opened to the 105 degrees and 180 degrees just by the simple structure composed of sleeve, sliding block, spring and button, it is simple-structure, reliable and lower-cost; secondly, the upper pan can rotate relative to left lever and right lever, when the upper and lower pans closed, the upper pan can auto-adjust the angle to adapt the thickness and shape of the grilling food, and the position function of the shaft can make the upper pan maintain angle of 105 degrees with the lower pan when it be opened so that the oil on the upper pan can flow down to the lower pan; thirdly, the shaft rotatably cooperates with the pivotal connection portion of the lower pan of the arc protruding rib, it increases the strength and reliability of the connection; fourthly, the said upper pan and lower pan forms a “V”-shape when they open to the utmost position by the supporting of the foot and the handle, it helps discharge the grease of the food.

### BRIEF DESCRIPTION OF THE DRAWINGS

FIG. 1 is a partial side view of the present invention;

FIG. 2 is a partial exploded view of the present invention;

FIG. 3 is a sectional view of the A-A in FIG. 1, which shows the status when the upper and lower pans opened in the utmost position;

FIG. 4 is a sectional view of the A-A in FIG. 1, it shows the status when the upper and lower pans opened in 105 degree.

FIG. 5 is a partial side view of the present invention without the right lever;

FIG. 6 is a partial sectional view of the present invention, in which shows the position of sliding block relative to the right lever when the upper and lower pan closed;

FIG. 7 is a partial view of the shaft of the present invention;

FIG. 8 illustrates the upper and lower pans opened in the utmost position.

### DETAILED DESCRIPTION OF THE INVENTION

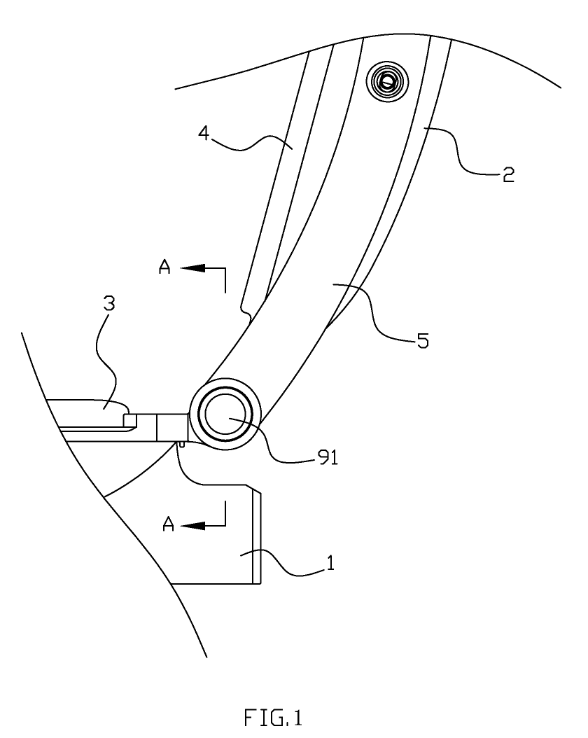

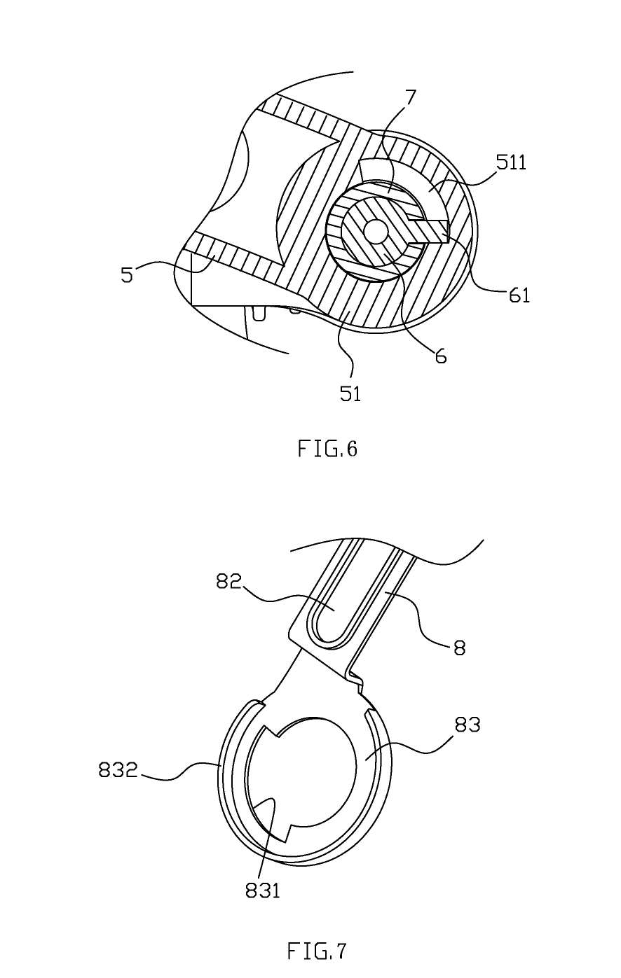

The preferred embodiment of the present invention will be detailed described with reference to FIG. 1 to FIG. 8.

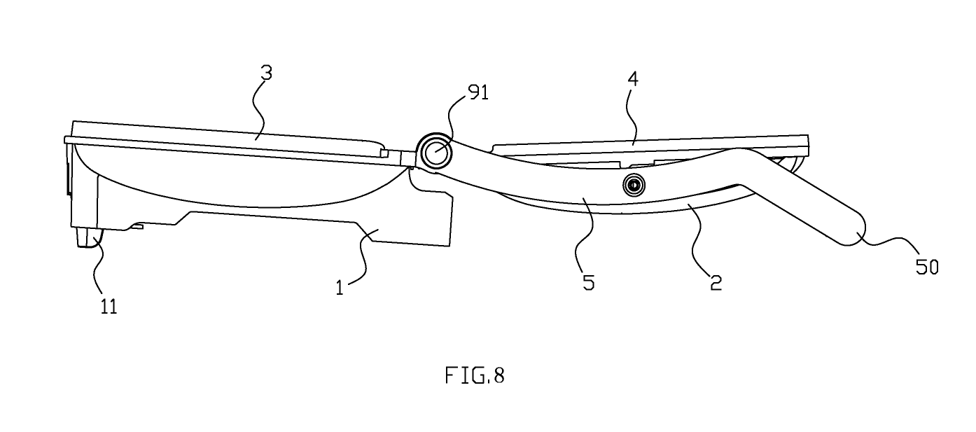

Referring to FIG. 1, a grill of the present invention comprises a base 1, an upper shell 2 and an upper pan 4 located under the upper shell 2 and an lower pan 3 located in the base 1, wherein the upper shell 2 has a left lever on the left side, and a right lever at the right side. One end of each of the two levers is pivotally connected to the back portion of the base at its corresponding side. Only the connecting structure of the right lever 5 and the back portion of the right side of the lower pan 3 are shown in the FIG. 1. The connecting structure of the right lever 5 and the back portion of the side of the lower pan 3 is a simple pivotal connection so that it is not described in more detail here. Referring further to FIG. 8, the extending terminals of the left and right levers are connected with each other and form a U-shape via a handle 50, the middle portion of the left lever and right lever 5 are pivotally connected with the left and right sides of the said upper shell 2 respectively. The upper pan 4 can rotate relative to the levers, such that when the upper pan 4 and lower pan 3 are closed, the upper pan 4 can auto-adjust its angle according to the thickness and shape of the food item being grilled.

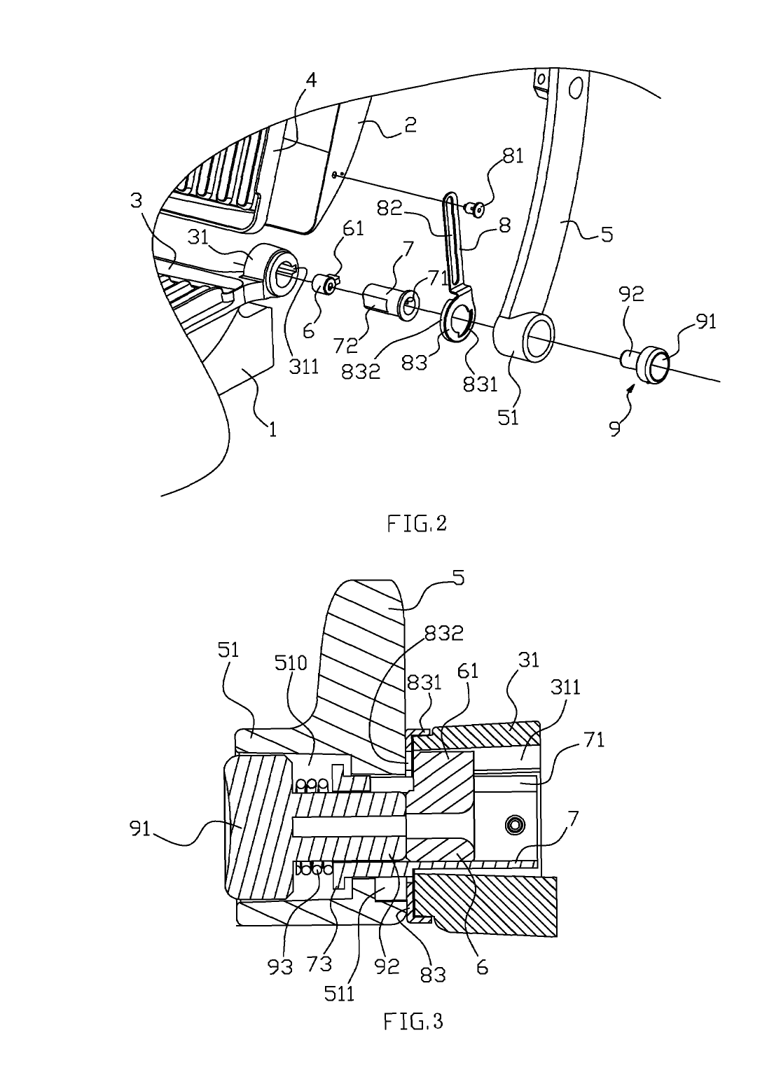

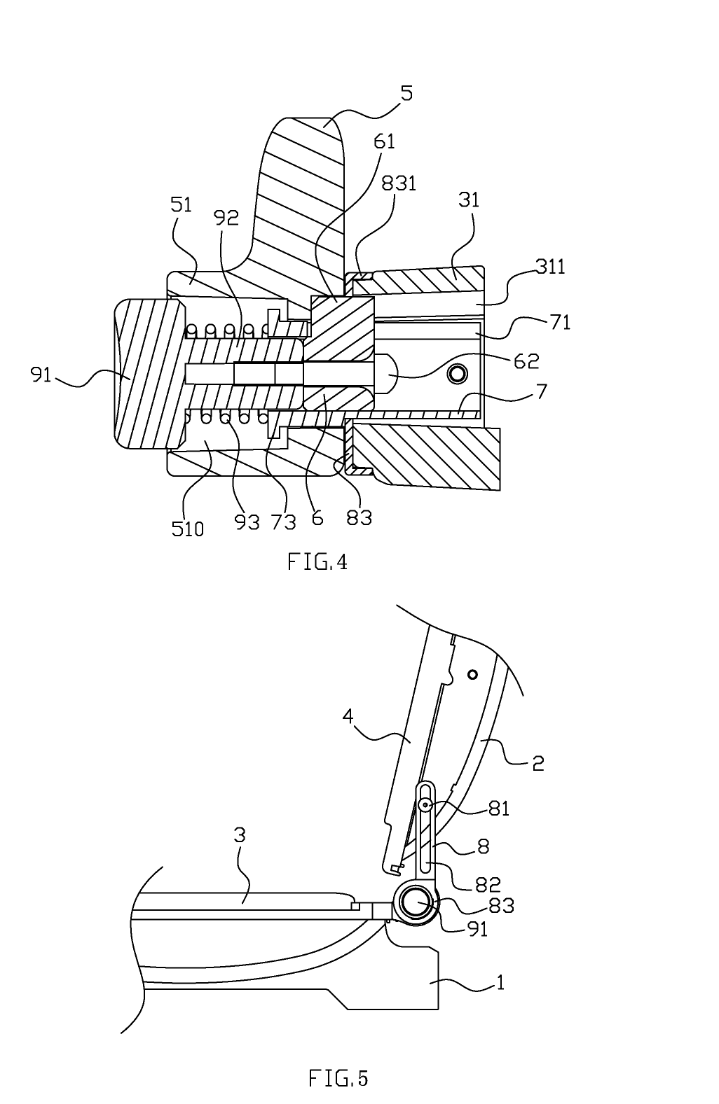

Referring to FIG. 2 and FIG. 4, a first pivotal connection portion 31 of the rear portion of the right side of the lower pan 3 is pivotally connected with a second pivotal connection portion 51 of the lower portion of the right lever 5 via a sleeve 7, and there is a sliding block 6 in the sleeve 7 which can slide along the axis direction of the sleeve 7; the side wall of the sliding block 6 has a position protrusion 61, the first pivotal connection portion 31 of the lower pan 3 has a corresponding position groove 311 for the position protrusion 61 sliding towards the axis direction, and referring to FIG. 6, the pivotal connection portion 51 of the said lever 5 has a corresponding arc limiting groove 511 for the position protrusion 61 rotating limitedly, the said sleeve 7 has a corresponding position opening 71 to the position groove 311.

When the sliding block 6 slide along the axis direction in the sleeve 7, the position protrusion 61 slides in the position groove 311 and position opening 71, the sliding block 6 can slide relative to the sleeve 7 and the first pivotal connection portion 31, but cannot rotate relative to them, and the sleeve 7 can not rotate relative to the first pivotal connection portion 31. The sleeve 7 can be positioned relative to the first pivotal connection portion 31 by a bolt locked from the bottom of the first pivotal connection portion 31 and by the action of the sectional plan 72 of the sleeve 7, thus the sleeve 7 can not rotate or slide relative to connection portion 31. Referring to FIG. 4 and FIG. 6, when the sliding block 6 is between the first pivotal connection portion 31 and the second pivotal connection portion 51, the position protrusion 61 will be partially inserted into the arc-limiting groove 511, thus the rotation of the right lever 5 relative to sleeve 7 will be limited by the arc limit groove 511. In an embodiment, the angle of the arc-limiting groove 511 is 105 degrees. Referring to FIG. 3, when the sliding block 6 slides completely into the first pivotal connection portion 31, the position protrusion 61 will be inserted completely into the position groove 311, thus the right lever 5 will not be limited, and the right lever 5 can rotate freely relative to sleeve 7 to 180 degrees.

Again referring to FIG. 2 to FIG. 4, the second pivotal connection portion 51 of the lever 5 has a button 9 for the sliding block 6 to slide between the first pivotal connection portion 31 of the lower pan 3 and the second pivotal connection portion 51 of the right lever 5. The sleeve 7 inserts into the first pivotal connection portion 31 of the lower pan 3 from the of the second pivotal connection portion 51 of the right lever 5. The outside of the sleeve has a flange 73 for preventing the sleeve from being over-inserted. The button 9 includes a head 91 and a shaft 92 with smaller dimension than the head, the shaft 92 inserts into the said sleeve 7, and a spring 93 is mounted between the head 91 and the outer side of the sleeve 7. The sliding block 6 is fixed inside of the shaft 92 via a bolt 62. When the button 9 is pressed, the sliding block 6 inserts into the first pivotal connection portion 31 of the lower pan 3 completely. When the button 9 is released, the sliding block 6 reverts to the position between the first pivotal connection portion 31 of the lower pan 3 and the second pivotal connection portion 51 of the right lever 5 by the action of spring 93. The second pivotal connection portion 51 of the right lever 5 is shaped to form an assemble groove 510 at the side opposite to the lower pan 3, in which groove the flange 73 of the outer side of sleeve 7, the head 91 of the button 9 and the spring 93 are mounted and protected.

Referring to FIG. 2 to FIG. 5 and FIG. 7, a shaft 8 is mounted on the sleeve 7, wherein one end of the shaft 8 forms a ring 83 rotatably sheathed the sleeve 7, the ring 83 being arranged between the pivotal connection portion 51 of the right lever 5 and the pivotal connection portion 31 of the lower pan 3. The shaft 8 has a sliding groove 82, the sliding groove 82 being slidably connected to the lower portion of the right side of the upper shell 2 via a rivet 81. The internal edge of the ring 83 of the said shaft 8 has an arc opening 831 cooperating to the position protrusion 61 of the sliding block 6. By the cooperation of the position protrusion 61 and the arc opening 831, the upper pan 4 can be positioned relative to the right lever 5 in the opening state, and forms an angle of 105 degrees with the lower pan 3 for discharging the grease of food. The side of the periphery of the ring 83 towards to the first pivotal connection portion 31 of the lower pan 3 has an arc protruding rib 832, and the arc protruding rib 832 and the periphery of the first pivotal connection portion 31 of the lower pan 3 forms rotating cooperation to enhance the reliability of the connection.

And referring to FIG. 8, the portions of the left lever and the right lever connected to the handle 50 are bended towards the top of the upper shell 4. In FIG. 8, it is bended down. The lower portion of the front portion of the base 1 has a foot 11, the upper pan 4 and lower pan 3 forms a “V”-shape when they open to the utmost position by the support of the foot 11 and the handle 50, thus helping discharge the grease of food.

Although the invention herein has been described with reference to the particular embodiment, it is to be understood that the embodiment is merely illustrative of the principles and applications of the present invention. It is therefore to be understood that numerous modifications may be made to the illustrative embodiment and that other arrangements may be devised without departing from the spirit and scope of the present invention as defined by the appended claims.

What is claimed is:

1. A grill comprising a base, an upper shell, an upper pan located in the upper shell and a lower pan located in the base,
wherein the upper shell has a left side with a left lever and a right side with a right lever,
wherein the lower pan has a left side and a right side each of which has a back portion, and one end of each of the left lever and right lever is pivotally connected to the back portion of the two sides of the lower pan respectively,
wherein the lower pan is pivotally connected to at least a lever via a sleeve having an axis direction, and wherein a sliding block in the sleeve can slide along the axis direction of the sleeve;
wherein the sliding block has an outer side which has a position protrusion, a first pivotal connection portion of the lower pan has a corresponding position groove for the position protrusion sliding along the axis direction of the sleeve, a second pivotal connection portion of the lever has a corresponding arc-limiting groove for the position protrusion to rotate limitedly, and the sleeve has a corresponding position opening to the position groove; and
wherein the lever has a button for the sliding block to slide from the position between the lever into the first pivotal connection portion of the lower pan.

2. The grill according to claim 1, wherein the sleeve inserts into the first pivotal connection portion of the lower pan from the second pivotal connection portion of the lever, and the outer side of the sleeve has a flange to limit the distance of its sliding movement; the button includes a head and a shaft smaller in dimension than the head, wherein the shaft inserts into the sleeve, and a spring is mounted between the head and the outer side of the sleeve.

3. The grill according to claim 2, wherein the sliding block is fixed in the inner side of the shaft via a bolt.

4. The grill according to claim 2, wherein the outer side of the pivotal connection portion of the lever opposite to the lower pan forms an assemble groove, and the flange of the sleeve, the head of the button and the spring between them are positioned in the assemble groove.

5. The grill according to claim 2, wherein the arc-limiting groove has an angle of about 105 degrees.

6. The grill according to claim 2, wherein the sleeve forms a non-reversible cooperation with the opposite first pivotal connection portion of the lower pan and reversible cooperation with the second pivotal connection portion of the lever.

7. The grill according to claim 1, wherein there is a shaft on the sleeve, one end of the shaft forms a ring sheathed on the sleeve, the ring being arranged between the second pivotal connection portion of the right lever and the first pivotal connection portion of the lower pan; wherein the lever is connected to the lower portion of the right side of the said upper shell via a sliding device; and the internal edge of the ring of the shaft has an arc opening corresponding to the position protrusion of the sliding block.

8. The grill according to claim 7, wherein the sliding device comprises a sliding groove on the shaft and a rivet on the right side of the upper shell, and the sliding groove of the shaft is connected slidably via the rivet.

9. The grill according to claim 7, wherein the side of the periphery of the ring toward the pivotal connection portion of the lower pan has an arc protruding rib, and the arc protruding rib and the periphery of the first pivotal connection portion of the lower pan form a rotating cooperation.

10. The grill according to claim 7, wherein the portion of the left lever and the right lever connecting to the handle bends towards the top of the upper shell, the lower portion of the front portion of the base has a foot, and the upper pan and lower pan forms a “V”-shape when opened to the utmost position.

11. A grill comprising a base, an upper shell, an upper pan located in the upper shell and an lower pan located in the base, wherein the left side of the upper shell has a left lever, the right side of the upper shell has a right lever, wherein one end of the two levers are connected with each other by a handle, and the other end of the two levers are each pivotally connected to a back portion of its corresponding side of the lower pan, wherein the lower portion of the front portion of the base has a foot, and the upper pan and lower pan forms a “V”-shape when they open to the utmost position by the supporting of the foot and the handle.

12. The grill according to claim 11, wherein the lower pan pivotally connects to at least a lever via a sleeve, which comprises a sliding block which can slide through the pivotal shaft; wherein the side of the sliding block has a position protrusion, the pivotal connection portion of the lower pan has a corresponding position groove for the position protrusion sliding through the shaft, the pivotal connection portion of the lever has a corresponding arc limiting groove for the position protrusion to rotate limitedly, the sleeve has a corresponding position opening to the position groove; and wherein the lever has a button for the sliding block to slide from the position between the lever and the pivotal connection portion of the lower pan into the pivotal connection portion of the lower pan.

13. The grill according to claim 12, wherein the sleeve inserts into the pivotal connection portion of the lower pan from the pivotal connection portion of the lever, and the outer side of the sleeve has a flange to limit the distance of its sliding movement, the button comprising a head and a shaft with a smaller dimension, the shaft inserts into the sleeve, and a spring mounted between the head and the outer side of the sleeve, wherein the sliding block is fixed in the inner side of the said shaft via a bolt.
